(19) United States
(12) Patent Application Publication
(10) Pub. No.: US 2025/0004717 A1
(43) Pub. Date: Jan. 2, 2025

(54) Semi-Constant Operand Multipliers

(71) Applicant: Google LLC, Mountain View, CA (US)

(72) Inventor: Herman Henry Schmit, Marina, CA (US)

(21) Appl. No.: 18/215,332

(22) Filed: Jun. 28, 2023

(51) Int. Cl. G06F 7/523; G06F 7/50

(52) U.S. Cl. CPC G06F 7/523; G06F 7/50

(57) ABSTRACT

Aspects of the disclosure are directed to multiplier circuits for semi-constant operand multiplication. The multiplier circuits can receive operands for multiplication. The multiplier circuits can convert one of the operands to a set of configuration bits, such as canonical signed digit representation (CSD). The multiplier circuits can process the other operand using the set of configuration bits to generate a multiplication output.

### BACKGROUND

A multiplier circuit can receive two input operands and output a multiplication output. The multiplier circuit can perform multiple operations with one of the operands held constant to reduce power consumed by the multiplier circuit and the memory access. However, the multiplier circuit can still consume more energy than necessary per multiplication operation. Further, the multiplier circuit can be designed to support rapid changing of both operands even though only one changes frequently, resulting in a larger than necessary multiplier circuit.

### BRIEF SUMMARY

Aspects of the disclosure are directed to multiplier circuits for semi-constant operand multiplication. The multiplier circuits can receive operands for multiplication. The multiplier circuits can convert one of the operands to a set of configuration bits, such as canonical signed digit representation (CSD). The multiplier circuits can process the other operand using the set of configuration bits to generate a multiplication output.

An aspect of the disclosure provides for a multiplier circuit for semi-constant operand multiplication including a first sub-circuit, a second sub-circuit, and one or more processors, the one or more processors configured to: receive a first operand and a second operand for multiplication; convert the first operand to signed digit representation, the signed digit representation including positive digits and negative digits; process the second operand in the first sub-circuit based on the positive digits to generate a positive field of the signed digit representation; process the second operand in the second sub-circuit based on the negative digits to generate a negative field of the signed digit representation; and subtract the negative field from the positive field to generate a multiplication output.

In an example, the second sub-circuit is a subset of the first sub-circuit. In another example, the first sub-circuit and second sub-circuit are equivalent.

In yet another example, the first sub-circuit includes one or more multiplexers and adder circuits. In yet another example, processing the second operand in the first sub-circuit further includes outputting outputs of the one or more multiplexers as inputs to one or more adder circuits. In yet another example, the second sub-circuit includes one or more multiplexers and adder circuits. In yet another example, processing the second operand in the second sub-circuit further includes outputting outputs of the one or more multiplexers as inputs to one or more adder circuits.

In yet another example, the one or more processors are further configured to swap positive terms of the positive field with negative terms of the negative field.

In yet another example, the multiplier circuit is implemented in at least one of a field programmable gate array (FPGA) or an application specific integrated circuit (ASIC).

Another aspect of the disclosure provides for a multiplier circuit for semi-constant operand multiplication including a processing circuit and one or more processors configured to: receive a first operand and a second operand for multiplication; convert the first operand to a set of configuration bits; and process the second operand using the set of configuration bits to generate a multiplication output.

In an example, converting the first operand to a set of configuration bits includes converting the first operand to signed digit representation. In another example, processing the second operand includes: processing the second operand in a first sub-circuit of the processing circuit using a first portion of the set of configuration bits to generate a first output; and processing the second operand in a second sub-circuit of the processing circuit using a second portion of the set of configuration bits to generate a second output. In yet another example, processing the second operand includes subtracting the second output from the first output to generate the multiplication output. In yet another example, the second sub-circuit is a subset of the first sub-circuit or the first sub-circuit and the second sub-circuit are equivalent.

In yet another example, the first sub-circuit includes one or more multiplexers and adder circuits. In yet another example, processing the second operand in the first sub-circuit further includes outputting outputs of the one or more multiplexers as inputs to one or more adder circuits. In yet another example, the second sub-circuit includes one or more multiplexers and adder circuits. In yet another example, processing the second operand in the second sub-circuit further includes outputting outputs of the one or more multiplexers as inputs to one or more adder circuits.

In yet another example, processing the second operand further includes swapping one or more outputs.

Yet another aspect of the disclosure provides or a method for semi-constant operand multiplication including: receiving, by one or more processors, a first operand and a second operand for multiplication; converting, by the one or more processors, the first operand to signed digit representation, the signed digit representation including positive digits and negative digits; processing, by the one or more processors, the second operand in a first sub-circuit of a multiplier circuit based on the positive digits to generate a positive field of the signed digit representation; processing, by the one or more processors, the second operand in a second sub-circuit of the multiplier circuit based on the negative digits to generate a negative field of the signed digit representation; and subtracting, by the one or more processors, the negative field from the positive field to generate a multiplication output.

### BRIEF DESCRIPTION OF THE DRAWINGS

FIG. 1 depicts a block diagram of an example multiplier circuit for semi-constant operand multiplication according to aspects of the disclosure.

FIG. 2 depicts a block diagram of an example multiplier circuit for semi-constant operand multiplication where a first input operand has been converted to signed digit representation according to aspects of the disclosure.

FIG. 3 depicts a block diagram of an example positive sub-circuit for a 3-bit unsigned multiplier according to aspects of the disclosure.

FIG. 4 depicts a block diagram of an example negative sub-circuit for a 3-bit unsigned multiplier according to aspects of the disclosure.

FIG. 5 depicts a block diagram of an example positive sub-circuit for an 8-bit signed multiplier according to aspects of the disclosure.

FIG. 6 depicts a block diagram of an example positive sub-circuit for an 8-bit signed multiplier that accounts for symmetry according to aspects of the disclosure.

FIG. 7 depicts a block diagram of an example negative sub-circuit for an 8-bit signed multiplier according to aspects of the disclosure.

FIG. 8 depicts a block diagram of an example multiplier circuit implementing a swapper according to aspects of the disclosure.

FIG. 9 depicts a block diagram of an example large term sub-circuit for an 8-bit signed multiplier according to aspects of the disclosure.

FIG. 10 depicts a block diagram of an example small term sub-circuit for an 8-bit signed multiplier according to aspects of the disclosure.

FIG. 11 depicts a block diagram of a data processing system implementing an example computation unit according to aspects of the disclosure.

FIG. 12 depicts a block diagram of an example environment for implementing a data processing system including a computation unit according to aspects of the disclosure.

### DETAILED DESCRIPTION

The technology relates generally to a multiplier circuit with at least one semi-constant operand. Semi-constant can refer to at least two consecutive multiplications. The multiplier circuit can receive as input two operands. The multiplier circuit can process one operand in two circuits to respectively generate a positive field and a negative field based on positive digits and negative digits of the other operand once encoded in a signed digit representation. The multiplier circuit can subtract the negative field from the positive field to generate an output that is a multiplication of the two operands.

The multiplier circuit allows for implementing semi-constant operands with reduced gate count, enabling more operators to be packed into the same space, reduced logic depth, enabling improved cycle time, and/or reduced switching, enabling reduced energy for producing a result. The multiplier circuit can be implemented in FPGAs or ASICs, like GPUs or TPUs, for performing machine learning inference or training.

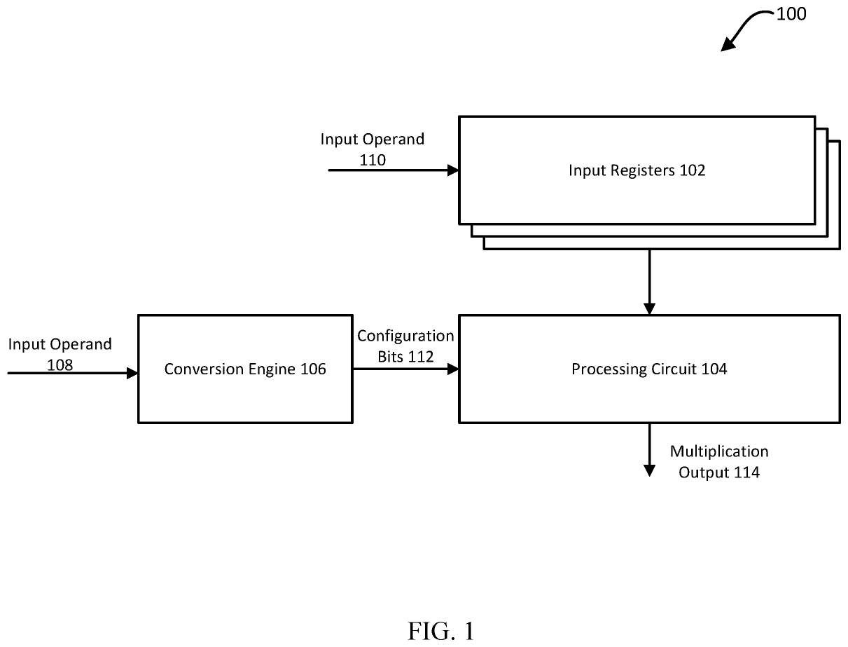

FIG. 1 depicts a block diagram of an example multiplier circuit 100 for semi-constant operand multiplication. The multiplier circuit 100 includes a plurality of input registers 102 and a processing circuit 104. The multiplier circuit 100 can further include a conversion engine 106. The multiplier circuit 100 can receive two input operands, such as a first input operand 108 and a second input operand 110. The multiplier circuit can receive the first input operand 108 at the conversion engine 106 and the second input operand 110 at the input registers 102. The conversion engine 106 can be configured to convert the first input operand 108 into a set of configuration bits 112 for providing to the processing circuit 104. The conversion engine 106 can convert the first input operand 108 into a set of configuration bits 112 based on a mapping. For example, the conversion engine 106 can convert a binary operand into a set of configuration bits associated with a signed digit representation, such as canonical signed digit (CSD) representation or Booth encoding. The conversion engine 106 can convert to binary operand using a table that enumerates some or all possible multiplicands.

The input registers 102 can be configured to retain the second input operand 110 for providing to the processing circuit 104. The processing circuit 104 can be configured to process the second input operand 110 using the set of configuration bits 112 to generate a multiplication output 114. The processing circuit 104 can include a plurality of multiplexers and adder circuits to account for the addition of non-zero terms in a signed digit representation. The multiplexers can select bits received from the input registers 102 based on the configuration bits 112. Outputs of the multiplexers can be provided to the adder circuits, which add the outputs to generate a multiplication output 114.

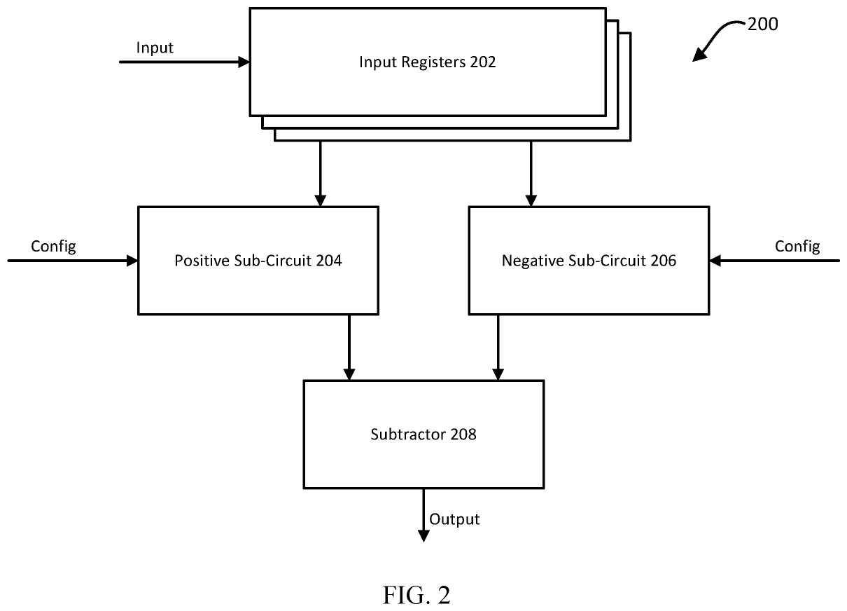

FIG. 2 depicts a block diagram of an example multiplier circuit 200 for semi-constant operand multiplication where a first input operand has been converted to a set of configuration bits associated with a signed digit representation. The multiplier circuit 200 can include a plurality of input registers 202, a positive sub-circuit 204, a negative sub-circuit 206, and a subtractor 208. The positive sub-circuit 204, negative sub-circuit 206, and subtractor 208 can correspond to the processing circuit 104 as depicted in FIG. 1. The plurality of input registers 202 can receive a second input operand. The plurality of input registers 202 can be configured to retain the input operand for providing as bits to the positive sub-circuit 204 and the negative sub-circuit 206.

The positive sub-circuit 204 and the negative sub-circuit 206 can also receive configuration bits, which are the first input operand converted to signed digit representation. The positive sub-circuit 204 can receive configuration bits corresponding to positive digits, referred to as positive digit bits, and the negative sub-circuit 206 can receive configuration bits corresponding to negative digits, referred to as negative digit bits. The negative sub-circuit 206 can be a subset of the positive sub-circuit 204 or equivalent to the positive sub-circuit 204. The positive sub-circuit 204 and the negative sub-circuit 206 can each include a plurality of multiplexers and adder circuits or logically equivalent circuits thereto. For the positive sub-circuit 204, the multiplexers can select bits received from the input registers 202 based on the positive digit bits. For the negative sub-circuit 206, the multiplexers can select bits received from the input registers 202 based on the negative digit bits. Outputs of the multiplexers can be provided to the adder circuits, which add the outputs to generate a positive field of the signed digit representation and a negative field of the signed digit representation respectively for the positive sub-circuit 204 and the negative sub-circuit 206. The subtractor 208 can be configured to subtract the negative field from the positive field to generate a multiplication output.

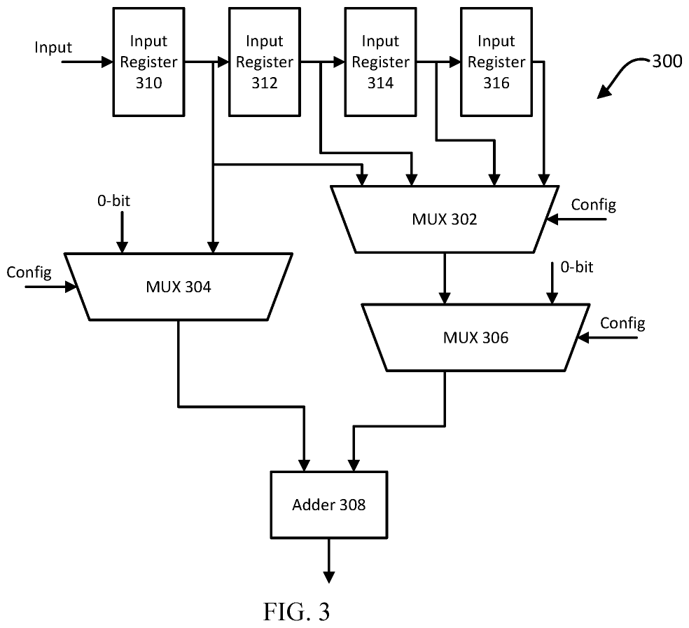

FIG. 3 depicts a block diagram of an example positive sub-circuit 300 for a 3-bit unsigned multiplier, e.g., supports multiplicands 0 to 7. The positive sub-circuit 300 can correspond to the positive sub-circuit 204 as depicted in FIG. 2.

The positive sub-circuit 300 can include a plurality of multiplexers, such as a first multiplexer 302, a second multiplexer 304, and a third multiplexer 306. The positive sub-circuit 300 can further include an adder circuit 308. The multiplexers 302, 304, 306 can receive configuration bits as positive digit bits. The positive digit bits can be positive terms of a first input operand converted to CSD representation. The first input operand can be converted to CSD representation using a table, such as the table depicted below for a 3-bit unsigned multiplier.

| | Binary | CSD+ |
|---|---|---|
| 0 | 000 | 0000 |
| 1 | 001 | 0001 |
| 2 | 010 | 0010 |
| 3 | 011 | 0010 |
| 4 | 100 | 0100 |
| 5 | 101 | 0101 |
| 6 | 110 | 1000 |
| 7 | 111 | 1000 |

The first multiplexer 302 can be a 4:1 multiplexer configured to receive four inputs from a plurality of registers, such as from first register 310, second register 312, third register 314, and fourth register 316. The plurality of registers can correspond to the registers 202 as depicted in FIG. 2. Since CSD representation for a 3-bit unsigned multiplexer includes four digits, the plurality of registers can correspond to four registers in this example. Based on a positive digit bit, the first multiplexer 302 can output one of the four inputs to the third multiplexer 306.

In other examples, the first multiplexer 302 can be a 3:1 multiplexer or the first multiplexer 302 can be a 4:1 multiplexer that receives a null bit input. The second multiplexer 304 can be a 2:1 multiplexer configured to receive an input from the plurality of registers, such as from the first register 310. The second multiplexer 304 also receives a null bit input. Based on a positive digit bit, the second multiplexer 304 can output the input from the plurality of registers or the null bit to the adder circuit 308. In other examples, the second multiplexer 304 can be replaced with an AND gate or any logically equivalent circuit.

In yet other examples, the second multiplexer 304 can be removed. The third multiplexer 306 can also be a 2:1 multiplexer configured to receive an input from the first multiplexer 302 as well as receive a null bit input. Based on a positive digit bit, the third multiplexer 306 can output the input from the first multiplexer 302 or the null bit to the adder circuit 308. In other examples, the third multiplexer 306 can be replaced with an AND gate or any logically equivalent circuit. The adder circuit 308 can be configured to add outputs received from the second multiplexer 304 and the third multiplexer 306 to generate an output representing positive terms.

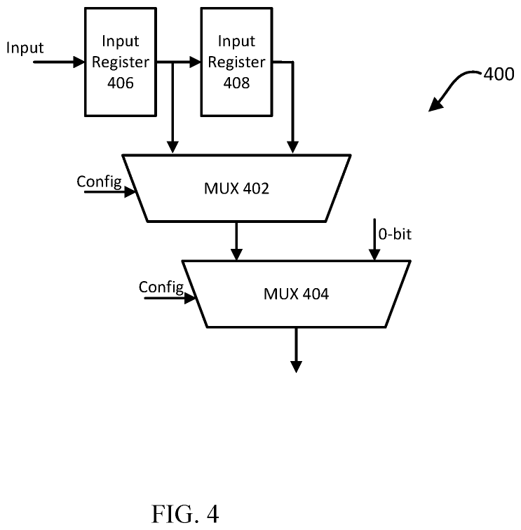

FIG. 4 depicts a block diagram of an example negative sub-circuit 400 for a 3-bit unsigned multiplier. The negative sub-circuit 400 can correspond to the negative sub-circuit 206 as depicted in FIG. 2. The negative sub-circuit 400 can be a subset of the positive sub-circuit 300 as depicted in FIG. 3 since the multiplier in this example involves unsigned bits.

The negative sub-circuit 400 can include a plurality of multiplexers, such as a first multiplexer 402 and a second multiplexer 404. The multiplexers 402, 404 can receive configuration bits as negative digit bits. The negative digit bits can be negative terms of a first input operand converted to CSD representation. The first input operand can be converted to CSD representation using a table, such as the table depicted below for a 3-bit unsigned multiplier.

| | Binary | CSD− |
|---|---|---|
| 0 | 000 | 0000 |
| 1 | 001 | 0000 |
| 2 | 010 | 0000 |
| 3 | 011 | 0001 |
| 4 | 100 | 0000 |
| 5 | 101 | 0000 |
| 6 | 110 | 0010 |
| 7 | 111 | 0001 |

The first multiplexer 402 can be a 2:1 multiplexer configured to receive two inputs from a plurality of registers, such as from first register 406 and second register 408. The plurality of registers can correspond to the registers 202 as depicted in FIG. 2. The plurality of registers for the negative sub-circuit 400 can be a subset of the plurality of registers for the positive sub-circuit 300 as depicted in FIG. 3. Based on a positive digit bit, the first multiplexer 402 can output one of the two inputs to the second multiplexer 404. The second multiplexer 404 can be a 2:1 multiplexer configured to receive an input from the first multiplexer 402 and a null bit input. Based on a positive digit bit, the second multiplexer 404 can output the input from the first multiplexer 402 or the null bit to generate an output representing negative terms. In other examples, the second multiplexer 404 can be replaced with an AND gate or any logically equivalent circuit.

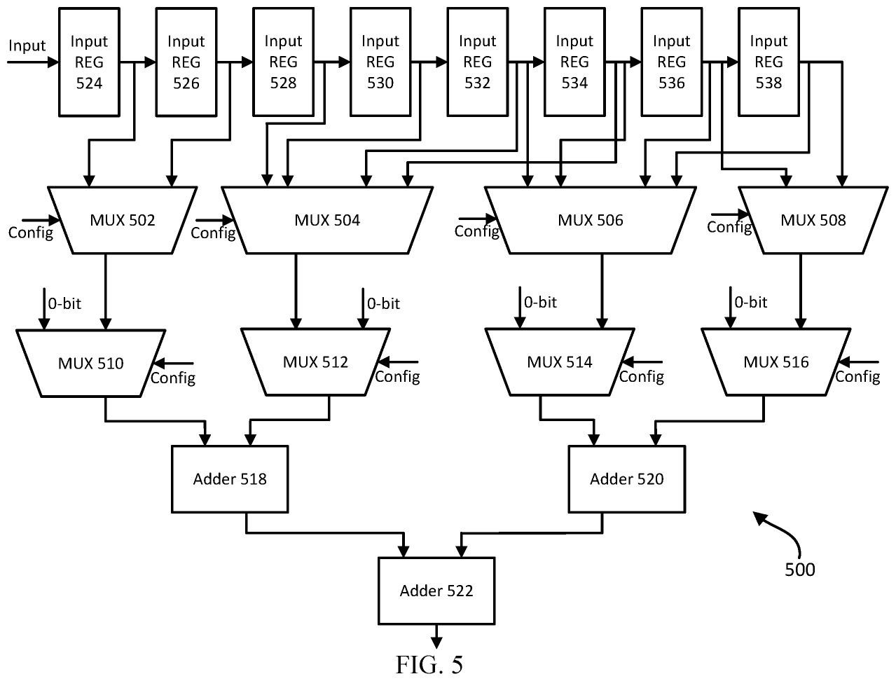

FIG. 5 depicts a block diagram of an example positive sub-circuit 500 for an 8-bit signed multiplier, e.g., supports multiplicands −128 to 128. The positive sub-circuit 500 can correspond to the positive sub-circuit 204 as depicted in FIG. 2.

The positive sub-circuit 500 can include a plurality of multiplexers, such as first multiplexer 502, second multiplexer 504, third multiplexer 506, fourth multiplexer 508, fifth multiplexer 510, sixth multiplexer 512, seventh multiplexer 514, and eighth multiplexer 516. The positive sub-circuit 500 can further include a plurality of adder circuits, such as first adder circuit 518, second adder circuit 520, and third adder circuit 522. The multiplexers 502-516 can receive configuration bits as positive digit bits. The positive digit bits can be positive terms of a first input operand converted to CSD representation. The first input operand can be converted to CSD representation using a table, such as the table depicted below for an 8-bit signed multiplier. For simplicity, only an excerpt of the table is depicted below, though one skilled in the art would understand the full table to include all numerals −128 to 128.

| | Binary | CSD+ |
|---|---|---|
| −128 | −10000000 | 00000000 |
| −91 | −01011011 | 00100101 |
| −85 | −01010101 | 00000000 |
| −3 | −00000011 | 00000001 |
| 3 | 00000011 | 00000100 |
| 85 | 01010101 | 01010101 |
| 91 | 01011011 | 10000000 |
| 128 | 10000000 | 10000000 |

The first multiplexer 502 can be a 2:1 multiplexer configured to receive two inputs from the plurality of registers, such as from first register 524 and second register 526. The plurality of registers can correspond to the registers 202 as depicted in FIG. 2. Since CSD representation for an 8-bit signed multiplexer includes eight digits, the plurality of registers can correspond to eight registers in this example. Based on a positive digit bit, the first multiplexer 502 can output one of the two inputs to the fifth multiplexer 510. The second multiplexer 504 can be a 4:1 multiplexer configured to receive four inputs from the plurality of registers, such as from third register 528, fourth register 530, fifth register 532, and sixth register 534. Based on a positive digit bit, the second multiplexer 504 can output one of the four inputs to the sixth multiplexer 512. The third multiplexer 506 can also be a 4:1 multiplexer configured to receive four inputs from the plurality of registers, such as from fifth register 532, sixth register 534, seventh register 536, and eighth register 538. Based on a positive digit bit, the third multiplexer 506 can output one of the four inputs to the seventh multiplexer 514. The fourth multiplexer 508 can be a 2:1 multiplexer configured to receive two inputs from the plurality of registers, such as from seventh register 536 and eighth register 538. Based on a positive digit bit, the fourth multiplexer 508 can output one of the two inputs to the eighth multiplexer 516.

The fifth multiplexer 510 can be a 2:1 multiplexer configured to receive an input from the first multiplexer 502 and a null bit input. Based on a positive digit bit, the fifth multiplexer 510 can output the input from the first multiplexer 502 or the null bit to the first adder circuit 518. The sixth multiplexer 512 can also be a 2:1 multiplexer configured to receive an input from the second multiplexer 504 and a null bit input. Based on a positive digit bit, the sixth multiplexer 512 can output the input from the second multiplexer 504 or the null bit to the first adder circuit 518. The seventh multiplexer 514 can yet also be a 2:1 multiplexer configured to receive an input from the third multiplexer 506 and a null bit input. Based on a positive digit bit, the seventh multiplexer 514 can output the input from the third multiplexer 506 or the null bit to the second adder circuit 520. The eighth multiplexer 516 can yet also be a 2:1 multiplexer configured to receive an input from the fourth multiplexer 508 and a null bit input. Based on a positive digit bit, the eighth multiplexer 516 can output the input from the fourth multiplexer 508 or the null bit to the second adder circuit 520. In other examples, one or more of the fifth, sixth, seventh, and eighth multiplexers 510-516 can be replaced with an AND gate or any logically equivalent circuit.

The first adder circuit 518 can be configured to add outputs received from the fifth multiplexer 510 and sixth multiplexer 512 to generate an output provided to the third adder circuit 522. The second adder circuit 520 can be configured to add outputs received from the seventh multiplexer 514 and eighth multiplexer 516 to generate an output also provided to the third adder circuit 522. The third adder circuit 522 can be configured to add outputs received from the first adder circuit 518 and second adder circuit 520 to generate an output representing positive terms.

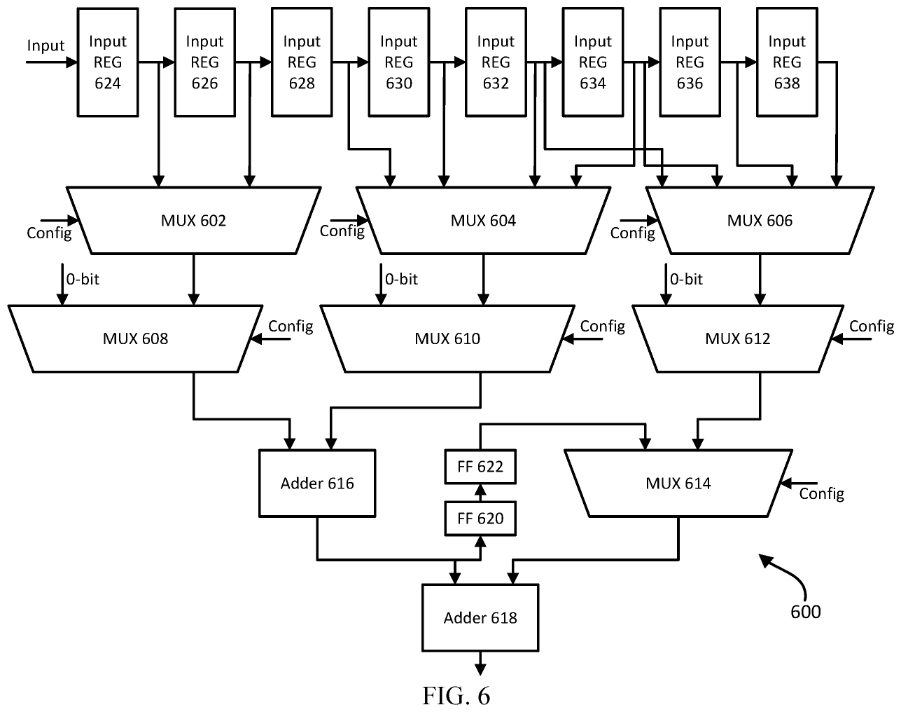

FIG. 6 depicts a block diagram of an example positive sub-circuit 600 for an 8-bit signed multiplier that accounts for symmetry in one or more of the CSD representations. Exploiting symmetry allows the positive sub-circuit 600 to generate the positive terms with fewer and/or smaller multiplexers, which can save space in a circuit package. The positive sub-circuit 600 can exploit symmetry by calculating a term, delaying the term for one or more cycles, and then adding that term to itself. For example, CSD representation of +85 has four positive terms, requiring three adders as depicted in FIG. 5, but since +85 in binary is 01010101, which replicates the pattern 0101, a multiplexer can calculate 0101 once and then after a delay of two cycles, that term can be added to itself to get 01010101.

The positive sub-circuit 600 can include a plurality of multiplexers, such as first multiplexer 602, second multiplexer 604, third multiplexer 606, fourth multiplexer 608, fifth multiplexer 610, sixth multiplexer 612, and seventh multiplexer 614. The positive sub-circuit 600 can further include a plurality of adder circuits, such as first adder circuit 616 and second adder circuit 618. The positive sub-circuit 600 can also include a plurality of flip flops, such as first flip flop 620 and second flip flop 622. The multiplexers 602-616 can receive configuration bits as positive digit bits. The positive digit bits can be positive terms of a first input operand converted to CSD representation.

The first multiplexer 602 can be a 2:1 multiplexer configured to receive two inputs from the plurality of registers, such as from first register 624 and second register 626. The plurality of registers can correspond to the registers 202 as depicted in FIG. 2. Based on a positive digit bit, the first multiplexer 602 can output one of the two inputs to the fourth multiplexer 608. The second multiplexer 604 can be a 4:1 multiplexer configured to receive four inputs from the plurality of registers, such as from third register 628, fourth register 630, fifth register 632, and sixth register 634. Based on a positive digit bit, the second multiplexer 604 can output one of the four inputs to the fifth multiplexer 610. The third multiplexer 606 can also be a 4:1 multiplexer configured to receive four inputs from the plurality of registers, such as from fifth register 632, sixth register 634, seventh register 636, and eighth register 638. Based on a positive digit bit, the third multiplexer 606 can output one of the four inputs to the sixth multiplexer 612.

The fourth multiplexer 608 can be a 2:1 multiplexer configured to receive an input from the first multiplexer 602 and a null bit input. Based on a positive digit bit, the fourth multiplexer 608 can output the input from the first multiplexer 602 or the null bit to the first adder circuit 616. The fifth multiplexer 610 can also be a 2:1 multiplexer configured to receive an input from the second multiplexer 604 and a null bit input. Based on a positive digit bit, the sixth multiplexer 610 can output the input from the second multiplexer 604 or the null bit to the first adder circuit 616. The sixth multiplexer 612 can yet also be a 2:1 multiplexer configured to receive an input from the third multiplexer 606 and a null bit input. Based on a positive digit bit, the sixth multiplexer 612 can output the input from the third multiplexer 606 or the null bit to the seventh multiplexer 614. In other examples, one or more of the fourth, fifth, and sixth multiplexers 608, 610, 612 can be replaced with an AND gate or any logically equivalent circuit.

The first adder circuit 616 can be configured to add outputs received from the fourth multiplexer 608 and fifth multiplexer 610 to generate an output provided to the second adder circuit 618. The output of the first adder circuit 616 can be also input to the first flip flop 620 to store the output of the first adder circuit 616 for a cycle. The output of the first flip flop 620 can be input to the second flip flop 622 to store the output of the first flip flop 620 for a cycle. The output of the second flip flop 622 can be input to the seventh multiplexer 614.

The seventh multiplexer 614 can be a 2:1 multiplexer configured to receive an input from the second flip flop 622 and an input from the sixth multiplexer 612. Based on a positive digit bit, the seventh multiplexer 614 can output one of the two inputs to the second adder circuit 618. The second adder circuit 618 can be configured to add outputs received from the first adder circuit 616 and the seventh multiplexer 614 to generate an output representing positive terms.

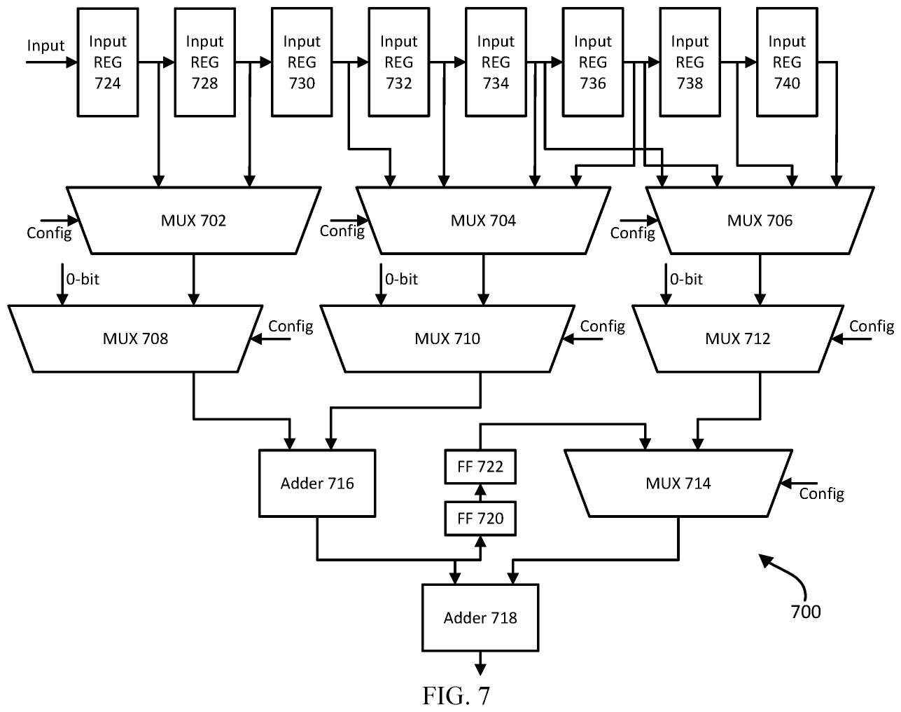

FIG. 7 depicts a block diagram of an example negative sub-circuit 700 for an 8-bit signed multiplier. The negative sub-circuit 700 can correspond to the negative sub-circuit 206 as depicted in FIG. 2. The negative sub-circuit 700 can be equivalent to its corresponding positive sub-circuit, such as the positive sub-circuit 500 as depicted in FIG. 5 or the positive sub-circuit 600 as depicted in FIG. 6, since the multiplier in this example involves signed bits. The negative sub-circuit 700 as depicted in FIG. 7 corresponds to the positive sub-circuit 600 as depicted in FIG. 6.

The negative sub-circuit 700 can include a plurality of multiplexers, such as first multiplexer 702, second multiplexer 704, third multiplexer 706, fourth multiplexer 708, fifth multiplexer 710, sixth multiplexer 712, and seventh multiplexer 714. The negative sub-circuit 700 can further include a plurality of adder circuits, such as first adder circuit 716 and second adder circuit 718. The negative sub-circuit 700 can also include a plurality of flip-flops, such as first flip flop 720 and second flip flop 722. The multiplexers 702-716 can receive configuration bits as negative digit bits. The negative digit bits can be negative terms of a first input operand converted to CSD representation. The first input operand can be converted to CSD representation using a table, such as the table depicted below for an 8-bit signed multiplier. For simplicity, only an excerpt of the table is depicted below, though one skilled in the art would understand the full table to include all numerals −128 to 128.

| | Binary | CSD− |
|---|---|---|
| −128 | −10000000 | 10000000 |
| −91 | −01011011 | 10000000 |
| −85 | −01010101 | 01010101 |
| −3 | −00000011 | 00000100 |
| 3 | 00000011 | 00000001 |
| 85 | 01010101 | 00000000 |
| 91 | 01011011 | 00100101 |
| 128 | 10000000 | 00000000 |

The first multiplexer 702 can be a 2:1 multiplexer configured to receive two inputs from the plurality of registers, such as from first register 724 and second register 726. The plurality of registers can correspond to the registers 202 as depicted in FIG. 2. Based on a negative digit bit, the first multiplexer 702 can output one of the two inputs to the fourth multiplexer 708. The second multiplexer 704 can be a 4:1 multiplexer configured to receive four inputs from the plurality of registers, such as from third register 728, fourth register 730, fifth register 732, and sixth register 734. Based on a negative digit bit, the second multiplexer 704 can output one of the four inputs to the fifth multiplexer 710. The third multiplexer 706 can also be a 4:1 multiplexer configured to receive four inputs from the plurality of registers, such as from fifth register 732, sixth register 734, seventh register 736, and eighth register 738. Based on a negative digit bit, the third multiplexer 706 can output one of the four inputs to the sixth multiplexer 712.

The fourth multiplexer 708 can be a 2:1 multiplexer configured to receive an input from the first multiplexer 702 and a null bit input. Based on a negative digit bit, the fourth multiplexer 708 can output the input from the first multiplexer 702 or the null bit to the first adder circuit 716. The fifth multiplexer 710 can also be a 2:1 multiplexer configured to receive an input from the second multiplexer 704 and a null bit input. Based on a negative digit bit, the sixth multiplexer 710 can output the input from the second multiplexer 704 or the null bit to the first adder circuit 716. The sixth multiplexer 712 can yet also be a 2:1 multiplexer configured to receive an input from the third multiplexer 706 and a null bit input. Based on a negative digit bit, the sixth multiplexer 712 can output the input from the third multiplexer 706 or the null bit to the seventh multiplexer 714. In other examples, one or more of the fourth, fifth, and sixth multiplexers 708, 710, 712 can be replaced with an AND gate or any logically equivalent circuit.

The first adder circuit 716 can be configured to add outputs received from the fourth multiplexer 708 and fifth multiplexer 710 to generate an output provided to the second adder circuit 718. The output of the first adder circuit 716 can be also input to the first flip flop 720 to store the output of the first adder circuit 716 for a cycle. The output of the first flip flop 720 can be input to the second flip flop 722 to store the output of the first flip flop 720 for a cycle. The output of the second flip flop 722 can be input to the seventh multiplexer 714.

The seventh multiplexer 714 can be a 2:1 multiplexer configured to receive an input from the second flip flop 722 and an input from the sixth multiplexer 712. Based on a negative digit bit, the seventh multiplexer 714 can output one of the two inputs to the second adder circuit 718. The second adder circuit 718 can be configured to add outputs received from the first adder circuit 716 and the seventh multiplexer 714 to generate an output representing negative terms.

While FIGS. 3-7 depict positive and negative sub-circuits for a 3-bit unsigned multiplier example and an 8-bit signed multiplier example, the positive and negative sub-circuits as depicted in FIG. 2 can be for an any-bit signed or unsigned multiplier. Further, while FIGS. 3-7 depict positive and negative sub-circuits for single-bit serial multiplication, the positive and negative sub-circuits as depicted in FIG. 2 can be for multiple-bit serial multiplication by including additional adder circuits and/or shift registers.

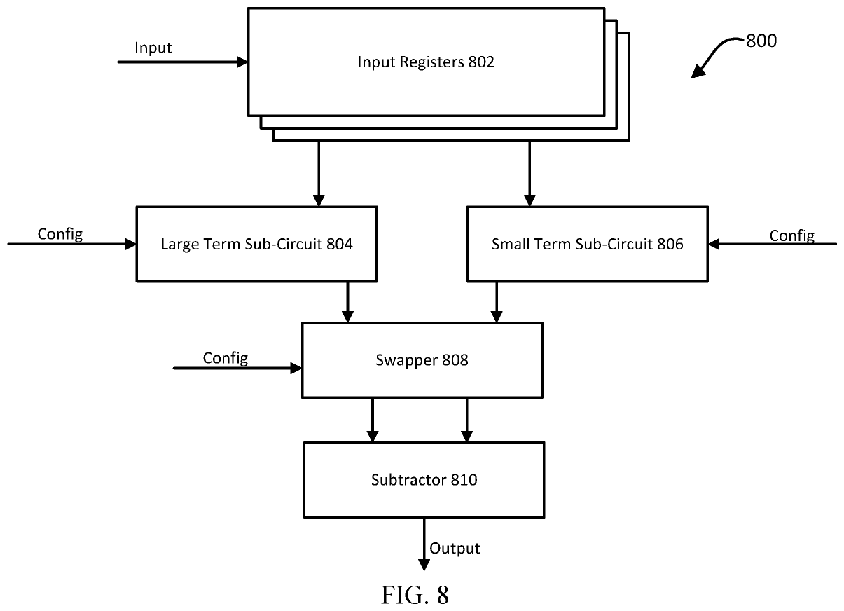

FIG. 8 depicts a block diagram of an example multiplier circuit 800 implementing a swapper to allow for fewer and/or smaller circuitry, thus saving space in a circuit package. In the example multiplier circuit 800, a first input operand has been converted to a set of configuration bits associated with a signed digit representation. The multiplier circuit 800 can include a plurality of input registers 802, a large term sub-circuit 804, a small term sub-circuit 806, a swapper 808, and a subtractor 810. The large term sub-circuit 804, small term sub-circuit 806, swapper 808, and subtractor 810 can correspond to the processing circuit 104 as depicted in FIG. 1. As an example, the large term sub-circuit 804 can correspond to a circuit for 1-4 terms of an operand and the small term sub-circuit 806 can correspond to a circuit for 1-2 terms of an operand. For example, in CSD representation of an n-bit number, the sum of “1”'s in the positive term and negative term will be less than or equal to half of n. Thus, if the positive term contains p “1”s, the negative term will have n/2−p “1”s or less, and vice-versa. Rather than split the processing circuit into positive and negative terms, the processing circuit can be split into the large term sub-circuit 804 and small term sub-circuit 806, with the swapper 808 configured to place the terms in the correct place for the subtractor 810.

The plurality of input registers 802 can receive a second input operand. The plurality of input registers 802 can be configured to store the input operand for providing as bits to the large term sub-circuit 804 and the small term sub-circuit 806.

The large term sub-circuit 804 and the small term sub-circuit 806 can also receive configuration bits, which are the first input operand converted to signed digit representation. The large term sub-circuit 804 can receive large term bits and the small term sub-circuit 806 can receive small term bits. The small term sub-circuit 806 can be a subset of the large term sub-circuit 804. The large term sub-circuit 804 and the small term sub-circuit 806 can each include a plurality of multiplexers and adder circuits. For the large term sub-circuit 804, the multiplexers can select bits received from the input registers 802 based on the large term bits. For the small term sub-circuit 806, the multiplexers can select bits received from the input registers 802 based on the small term bits. Outputs of the multiplexers can be provided to the adder circuits, which add the outputs to generate a first field of large terms of the signed digit representation and a second field of small terms of the signed digit representation respectively for the large term sub-circuit 804 and the small term sub-circuit 806. The swapper 808 can be configured, based on a received configuration bit, to swap large terms with small terms respectively from the first field and the second field to generate a swapped first field and a swapped second field. Based on the received configuration bit, the swapper 808 may also leave the large terms and small terms as is. The subtractor 810 can be configured to subtract the swapped second field from the swapped first field or, if not swapped, the second field from the first field to generate a multiplication output.

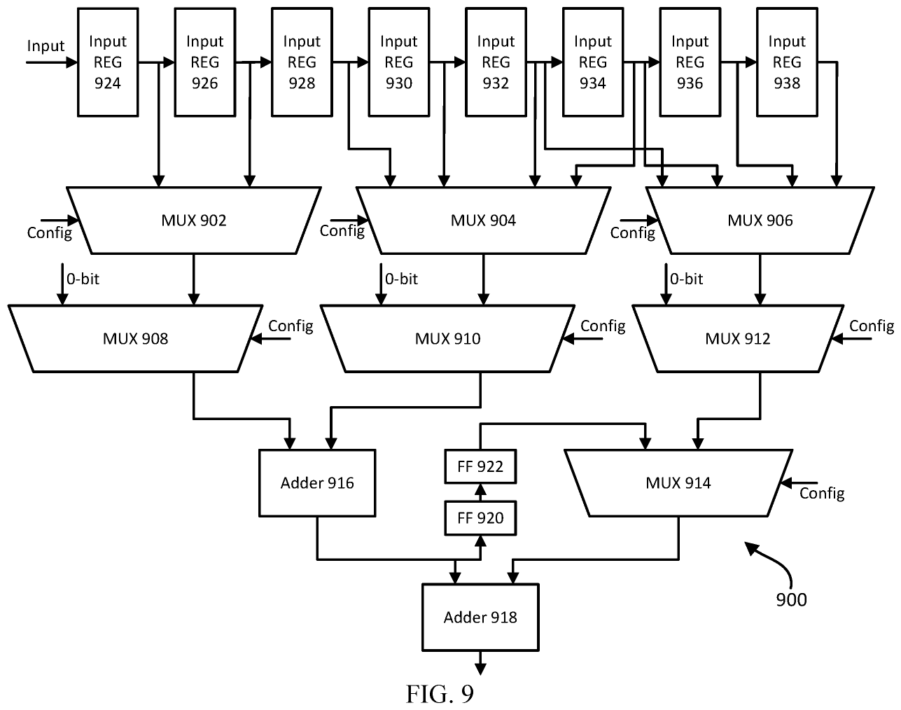

FIG. 9 depicts a block diagram of an example large term sub-circuit 900 for an 8-bit signed multiplier. The large term sub-circuit 900 can correspond to the large term sub-circuit 804 as depicted in FIG. 8. The large term sub-circuit 900 can correspond to a positive sub-circuit, such as the positive sub-circuit 500 as depicted in FIG. 5 or the positive sub-circuit 600 as depicted in FIG. 6. The large term sub-circuit 900 as depicted in FIG. 9 corresponds to the positive sub-circuit 600 as depicted in FIG. 6.

The large term sub-circuit 900 can include a plurality of multiplexers, such as first multiplexer 902, second multiplexer 904, third multiplexer 906, fourth multiplexer 908, fifth multiplexer 910, sixth multiplexer 912, and seventh multiplexer 914. The large term sub-circuit 900 can further include a plurality of adder circuits, such as first adder circuit 916 and second adder circuit 918. The large term sub-circuit 900 can also include a plurality of flip-flops, such as first flip flop 920 and second flip flop 922. The multiplexers 902-916 can receive configuration bits as large term bits. The large term bits can be 1-4 terms of a first input operand converted to CSD representation. The first input operand can be converted to CSD representation using a table.

The first multiplexer 902 can be a 2:1 multiplexer configured to receive two inputs from the plurality of registers, such as from first register 924 and second register 926. The plurality of registers can correspond to the registers 802 as depicted in FIG. 8. Based on a large term bit, the first multiplexer 902 can output one of the two inputs to the fourth multiplexer 908. The second multiplexer 904 can be a 4:1 multiplexer configured to receive four inputs from the plurality of registers, such as from third register 928, fourth register 930, fifth register 932, and sixth register 934. Based on a large term bit, the second multiplexer 904 can output one of the four inputs to the fifth multiplexer 910. The third multiplexer 906 can also be a 4:1 multiplexer configured to receive four inputs from the plurality of registers, such as from fifth register 932, sixth register 934, seventh register 936, and eighth register 938. Based on a large term bit, the third multiplexer 906 can output one of the four inputs to the sixth multiplexer 912.

The fourth multiplexer 908 can be a 2:1 multiplexer configured to receive an input from the first multiplexer 902 and a null bit input. Based on a large term bit, the fourth multiplexer 908 can output the input from the first multiplexer 902 or the null bit to the first adder circuit 916. The fifth multiplexer 910 can also be a 2:1 multiplexer configured to receive an input from the second multiplexer 904 and a null bit input. Based on a large term bit, the sixth multiplexer 910 can output the input from the second multiplexer 904 or the null bit to the first adder circuit 916. The sixth multiplexer 912 can yet also be a 2:1 multiplexer configured to receive an input from the third multiplexer 906 and a null bit input. Based on a large term bit, the sixth multiplexer 912 can output the input from the third multiplexer 906 or the null bit to the seventh multiplexer 914. In other examples, one or more of the fourth, fifth, and sixth multiplexers 908, 910, 912 can be replaced with an AND gate or any logically equivalent circuit.

The first adder circuit 916 can be configured to add outputs received from the fourth multiplexer 908 and fifth multiplexer 910 to generate an output provided to the second adder circuit 918. The output of the first adder circuit 916 can be also input to the first flip flop 920 to store the output of the first adder circuit 916 for a cycle. The output of the first flip flop 920 can be input to the second flip flop 922 to store the output of the first flip flop 920 for a cycle. The output of the second flip flop 922 can be input to the seventh multiplexer 914.

The seventh multiplexer 914 can be a 2:1 multiplexer configured to receive an input from the second flip flop 922 and an input from the sixth multiplexer 912. Based on a large term bit, the seventh multiplexer 914 can output one of the two inputs to the second adder circuit 918. The second adder circuit 918 can be configured to add outputs received from the first adder circuit 916 and the seventh multiplexer 914 to generate an output representing large terms.

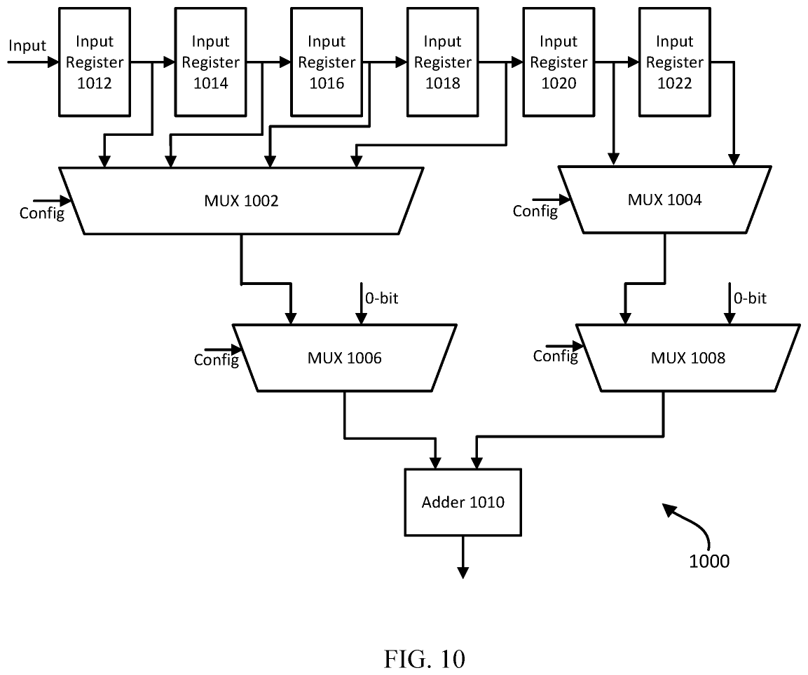

FIG. 10 depicts a block diagram of an example small term sub-circuit 1000 for an 8-bit signed multiplier. The small term sub-circuit 1000 can correspond to the small term sub-circuit 806 as depicted in FIG. 8. The small term sub-circuit 1000 can be a subset of the large term sub-circuit 900 as depicted in FIG. 9.

The small term sub-circuit 1000 can include a plurality of multiplexers, such as first multiplexer 1002, second multiplexer 1004, third multiplexer 1006, and fourth multiplexer 1008. The small term sub-circuit 1000 can further include one or more adder circuits, such as adder circuit 1010. The multiplexers 1002-1008 can receive configuration bits as small term bits. The small term bits can be 1-2 terms of a first input operand converted to CSD representation. The first input operand can be converted to CSD representation using a table.

The first multiplexer 1002 can be a 4:1 multiplexer configured to receive four inputs from the plurality of registers, such as from first register 1012, second register 1014, third register 1016, and fourth register 1018. The plurality of registers can correspond to the registers 802 as depicted in FIG. 8. Based on a small term bit, the first multiplexer 1002 can output one of the four inputs to the third multiplexer 1006. The second multiplexer 1004 can be a 2:1 multiplexer configured to receive two inputs from the plurality of registers, such as from fifth register 1020 and sixth register 1022. Based on a small term bit, the second multiplexer 1004 can output one of the two inputs to the fourth multiplexer 1008.

The third multiplexer 1006 can be a 2:1 multiplexer configured to receive an input from the first multiplexer 1002 and a null bit input. Based on a small term bit, the third multiplexer 1006 can output the input from the first multiplexer 1002 or the null bit to the adder circuit 1010. The fourth multiplexer 1008 can also be a 2:1 multiplexer configured to receive an input from the second multiplexer 1004 and a null bit input. Based on a small term bit, the fourth multiplexer 1008 can output the input from the second multiplexer 1004 or the null bit to the adder circuit 1010. In other examples, one or more of the third and fourth multiplexers 1006, 1008 can be replaced with an AND gate or any logically equivalent circuit.

The adder circuit 1010 can be configured to add outputs received from the third multiplexer 1006 and fourth multiplexer 1008 to generate an output representing small terms.

While FIGS. 9-10 depict large term and small term sub-circuits for an 8-bit signed multiplier example, the large term and small term sub-circuits as depicted in FIG. 8 can be for an any-bit signed or unsigned multiplier. Further, while FIGS. 9-10 depict large term and small term sub-circuits for single-bit serial multiplication, the large term and small term sub-circuits as depicted in FIG. 8 can be for multiple-bit serial multiplication by including additional adder circuits and/or shift registers.

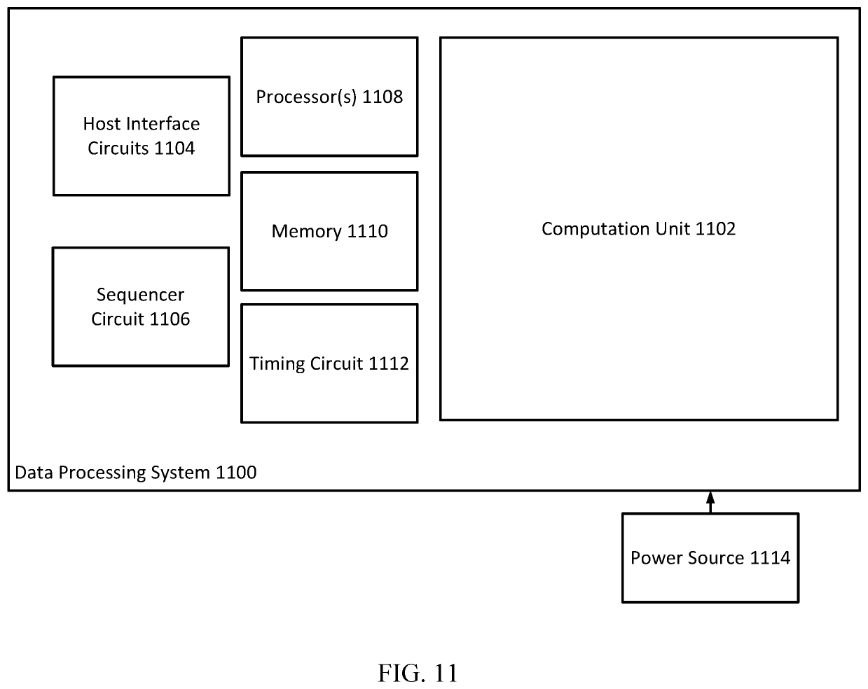

FIG. 11 depicts a block diagram of a data processing system 1100 implementing an example computation unit 1102. The computation unit 1102 can be or include any of a variety of different computation units, for example the multiplier circuits as depicted in FIG. 1-2 or 8.

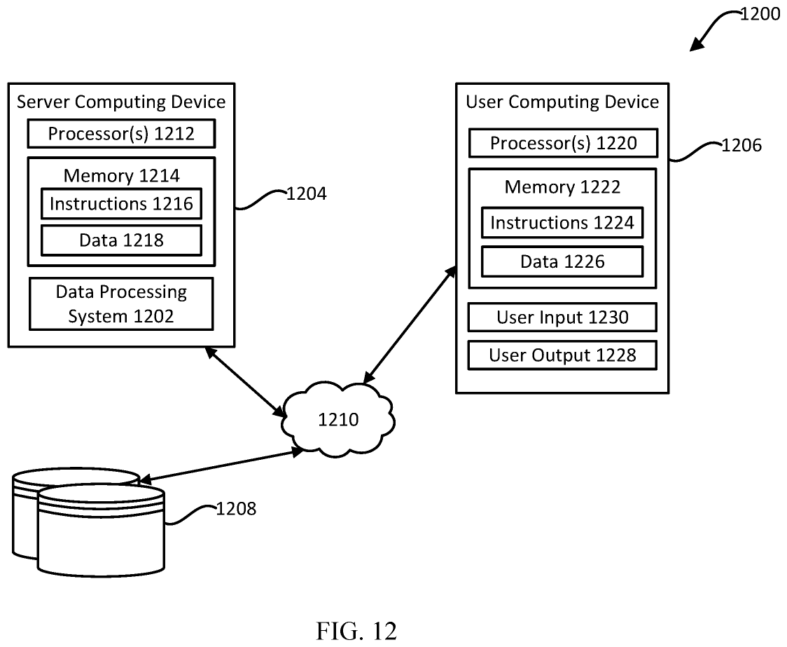

The data processing system 1100 can include a host interface 1104, a sequencer circuit 1106, one or more processors 1108, memory 1110, and a timing circuit 1112. The data processing system 1100 can be implemented in one or more devices across one or more physical locations, as described further with respect to FIG. 12. In some examples, the components of the data processing system 1100 can be implemented on one or more chips, which can interface with a host device according to any of a variety of data bus or other physical interconnect interfaces. In some examples, the data processing system 1100 can be implemented on one or more devices on a network, e.g., on one or more servers of a cloud platform.

The processors 1108 and memory 1110 can be any of a variety of different types of processors and memory as described herein with reference to FIG. 12. In some examples, the processors 1108 receive instructions that are executable by the computation unit 1102 for processing data. For example, the instructions can be part of a computer program written for performing operations using the computation unit 1102.

The sequencer circuit 1106 can convert the received instructions into one or more signals understood by the computation unit 1102 which causes the computation unit 1102 to perform any of a variety of preconfigured operations. These operations can include loading data, e.g., from the memory 1110, into a multiplier circuit of the computation unit 1102, moving data into one or more processing elements of the multiplier circuit, processing the data by the one or more processing elements, and pushing the data out of the multiplier circuit. The sequencer circuit 1106 can also be configured to generate one or more control signals for controlling when instructions are pushed to the computation unit 1102.

The host interface 1104 can be configured to receive data from outside the data processing system 1100, e.g., from a processor or another device, and send data generated by the computation unit 1102, e.g., the product of matrix multiplication, to outside the data processing system 1100, e.g., to one or more devices or processors.

The timing circuit 1112 can be configured to control timing of the computation unit 1102, e.g., its clock frequency or clock rate. For example, operations performed by the computation unit 1102 may be performed once per clock cycle, with such clock cycles managed by the timing circuit 1112.

The data processing system 1100 can also be connected to a power source 1114. The power source 1114 can be a battery or other form of power available on a host device implementing the data processing system 1100 or can be a source external to the host device and connected to the host device and the data processing system 1100 through some wireless or physical connection, e.g., through wires. The power source 1114 can supply voltage to the computation unit 1102, which can be managed, e.g., adjusted higher or lower, by the processors 1108.

FIG. 12 depicts a block diagram of an example environment 1200 for implementing a data processing system 1202 including a computation unit. The data processing system 1202 can correspond to the data processing system 1100 as depicted in FIG. 11. The data processing system 1202 can be implemented on one or more devices having one or more processors in one or more locations, such as in server computing device 1204. User computing device 1206 and the server computing device 1204 can be communicatively coupled to one or more storage devices 1208 over a network 1210. The storage devices 1208 can be a combination of volatile and non-volatile memory and can be at the same or different physical locations than the computing devices 1204, 1206. For example, the storage devices 1208 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 1204 can include one or more processors 1212 and memory 1214. The memory 1214 can store information accessible by the processors 1212, including instructions 1216 that can be executed by the processors 1212. The memory 1214 can also include data 1218 that can be retrieved, manipulated, or stored by the processors 1212. The memory 1214 can be a type of non-transitory computer readable medium capable of storing information accessible by the processors 1212, such as volatile and non-volatile memory. The processors 1212 can include one or more central processing units (CPUs), graphic processing units (GPUs), field-programmable gate arrays (FPGAs), and/or application-specific integrated circuits (ASICs), such as tensor processing units (TPUs).

The instructions 1216 can include one or more instructions that when executed by the processors 1212, causes the one or more processors 1212 to perform actions defined by the instructions 1216. The instructions 1216 can be stored in object code format for direct processing by the processors 1212, or in other formats including interpretable scripts or collections of independent source code modules that are interpreted on demand or compiled in advance. The instructions 1216 can include instructions for implementing the data processing system 1202 as described herein. The data processing system 1202 can be executed using the processors 1212, and/or using other processors remotely located from the server computing device 1204.

The data 1218 can be retrieved, stored, or modified by the processors 1212 in accordance with the instructions 1216. The data 1218 can be stored in computer registers, in a relational or non-relational database as a table having a plurality of different fields and records, or as JSON, YAML, proto, or XML documents. The data 1218 can also be formatted in a computer-readable format such as, but not limited to, binary values, ASCII or Unicode. Moreover, the data 1218 can include information sufficient to identify relevant information, such as numbers, descriptive text, proprietary codes, pointers, references to data stored in other memories, including other network locations, or information that is used by a function to calculate relevant data.

The user computing device 1206 can also be configured similarly to the server computing device 1204, with one or more processors 1220, memory 1222, instructions 1224, and data 1226. The user computing device 1206 can also include a user output 1228, and a user input 1230. The user input 1230 can include any appropriate mechanism or technique for receiving input from a user, such as keyboard, mouse, mechanical actuators, soft actuators, touchscreens, microphones, and sensors.

The server computing device 1204 can be configured to transmit data to the user computing device 1206, and the user computing device 1206 can be configured to display at least a portion of the received data on a display implemented as part of the user output 1228. The user output 1228 can also be used for displaying an interface between the user computing device 1206 and the server computing device 1204. The user output 1228 can alternatively or additionally include one or more speakers, transducers or other audio outputs, a haptic interface or other tactile feedback that provides non-visual and non-audible information to the platform user of the user computing device 1206.

Although FIG. 12 illustrates the processors 1212, 1220 and the memories 1214, 1222 as being within the computing devices 1204, 1206, components described herein can include multiple processors and memories that can operate in different physical locations and not within the same computing device. For example, the processors 1212 can include a collection of processors that can perform concurrent and/or sequential operation.

The server computing device 1204 can be configured to receive requests to process data from the user computing device 1206. For example, the environment 1200 can be part of a computing platform configured to provide a variety of services to users, through various user interfaces and/or APIs exposing the platform services. One or more services can be a machine learning framework or a set of tools for generating neural networks or other machine learning models according to a specified task and training data. The user computing device 1206 may receive and transmit data specifying operations to be performed by the computation unit of the data processing system 1202.

The computing devices 1204, 1206 can be capable of direct and indirect communication over the network 1210. The computing devices 1204, 1206 can set up listening sockets that may accept an initiating connection for sending and receiving information. The network 1210 itself can include various configurations and protocols including the Internet, World Wide Web, intranets, virtual private networks, wide area networks, local networks, and private networks using communication protocols proprietary to one or more companies. The network 1210 can support a variety of short- and long-range connections. The short- and long-range connections may be made over different bandwidths, such as 2.402 GHz to 2.480 GHz (commonly associated with the Bluetooth® standard), 2.4 GHZ and 11 GHZ (commonly associated with the Wi-Fi® communication protocol); or with a variety of communication standards, such as the LTER standard for wireless broadband communication. The network 1210, in addition or alternatively, can also support wired connections between the computing devices 1204, 1206, including over various types of Ethernet connection.

Although a single server computing device 1204, user computing device 1206, and data processing system 1202 are shown in FIG. 12, it is understood that aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof. In some examples, one or more devices implement one or more data processing systems, each data processing system including one or more computation units according to aspects of the disclosure. In some examples, a single device can implement multiple computation units, each of the multiple computation units configured to communicate with at least one other computation unit for performing a distributed data processing task, e.g., in sequential or parallel processing.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A multiplier circuit for semi-constant operand multiplication comprising a first sub-circuit, a second sub-circuit, and one or more processors, the one or more processors configured to:
receive a first operand and a second operand for multiplication;
convert the first operand to signed digit representation, the signed digit representation comprising positive digits and negative digits;
process the second operand in the first sub-circuit based on the positive digits to generate a positive field of the signed digit representation;
process the second operand in the second sub-circuit based on the negative digits to generate a negative field of the signed digit representation; and
subtract the negative field from the positive field to generate a multiplication output.

2. The multiplier circuit of claim 1, wherein the second sub-circuit is a subset of the first sub-circuit.

3. The multiplier circuit of claim 1, wherein the first sub-circuit and second sub-circuit are equivalent.

4. The multiplier circuit of claim 1, wherein the first sub-circuit comprises one or more multiplexers and adder circuits.

5. The multiplier circuit of claim 4, wherein processing the second operand in the first sub-circuit further comprises outputting outputs of the one or more multiplexers as inputs to one or more adder circuits.

6. The multiplier circuit of claim 1, wherein the second sub-circuit comprises one or more multiplexers and adder circuits.

7. The multiplier circuit of claim 6, wherein processing the second operand in the second sub-circuit further comprises outputting outputs of the one or more multiplexers as inputs to one or more adder circuits.

8. The multiplier circuit of claim 1, wherein the one or more processors are further configured to swap positive terms of the positive field with negative terms of the negative field.

9. The multiplier circuit of claim 1, wherein the multiplier circuit is implemented in at least one of a field programmable gate array (FPGA) or an application specific integrated circuit (ASIC).

10. A multiplier circuit for semi-constant operand multiplication comprising a processing circuit and one or more processors configured to:
receive a first operand and a second operand for multiplication;
convert the first operand to a set of configuration bits; and
process the second operand using the set of configuration bits to generate a multiplication output.

11. The multiplier circuit of claim 10, wherein converting the first operand to a set of configuration bits comprises converting the first operand to signed digit representation.

12. The multiplier circuit of claim 10, wherein processing the second operand comprises:
processing the second operand in a first sub-circuit of the processing circuit using a first portion of the set of configuration bits to generate a first output; and
processing the second operand in a second sub-circuit of the processing circuit using a second portion of the set of configuration bits to generate a second output.

13. The multiplier circuit of claim 12, wherein processing the second operand comprises subtracting the second output from the first output to generate the multiplication output.

14. The multiplier circuit of claim 12, wherein the second sub-circuit is a subset of the first sub-circuit or the first sub-circuit and the second sub-circuit are equivalent.

15. The multiplier circuit of claim 12, wherein the first sub-circuit comprises one or more multiplexers and adder circuits.

16. The multiplier circuit of claim 15, wherein processing the second operand in the first sub-circuit further comprises outputting outputs of the one or more multiplexers as inputs to one or more adder circuits.

17. The multiplier circuit of claim 12, wherein the second sub-circuit comprises one or more multiplexers and adder circuits.

18. The multiplier circuit of claim 17, wherein processing the second operand in the second sub-circuit further comprises outputting outputs of the one or more multiplexers as inputs to one or more adder circuits.

19. The multiplier circuit of claim 10, wherein processing the second operand further comprises swapping one or more outputs.

20. A method for semi-constant operand multiplication comprising:
receiving, by one or more processors, a first operand and a second operand for multiplication;
converting, by the one or more processors, the first operand to signed digit representation, the signed digit representation comprising positive digits and negative digits;
processing, by the one or more processors, the second operand in a first sub-circuit of a multiplier circuit based on the positive digits to generate a positive field of the signed digit representation;
processing, by the one or more processors, the second operand in a second sub-circuit of the multiplier circuit based on the negative digits to generate a negative field of the signed digit representation; and
subtracting, by the one or more processors, the negative field from the positive field to generate a multiplication output.
